(19) United States
(12) Patent Application Publication
(10) Pub. No.: US 2024/0429777 A1
(43) Pub. Date: Dec. 26, 2024

(54) LUBRICANT SUPPORTED ELECTRIC MOTOR WITH BEARING SUPPORT

(71) Applicant: Neapco Intellectual Property Holdings, LLC, Farmington Hills, MI (US)

(72) Inventors: Donald Remboski, Ann Arbor, MI (US); Jacqueline Dedo, Wolverine Lake, MI (US); Mark Versteyhe, Oostkamp (BE)

(21) Appl. No.: 18/824,301

(22) Filed: Sep. 4, 2024

Related U.S. Application Data
(63) Continuation of application No. 16/529,253, filed on Aug. 1, 2019.
(60) Provisional application No. 62/744,780, filed on Oct. 12, 2018.
(60) Provisional application No. 62/713,595, filed on Aug. 2, 2018.

(51) Int. Cl. H02K 5/24; H02K 7/00; H02K 7/08; H02K 7/116; H02K 7/12

(52) U.S. Cl. CPC H02K 5/24; H02K 7/006; H02K 7/08; H02K 7/116; H02K 7/12; H02K 2205/03

(57) ABSTRACT

An electric motor includes a stator and a rotor movably disposed within the stator to define a gap therebetween. A central shaft extends outwardly from the rotor, and a bearing element is disposed in supporting relationship with the central shaft for providing bearing support of the rotor within the stator. A lubricant is disposed in the gap for providing additional or auxiliary lubricant support of the rotor within the stator. In an alternative arrangement, the central shaft is operably connected with a drive assembly, which is operably connected with a wheel hub assembly. In this arrangement, the bearing element is disposed in supporting relationship with the wheel hub assembly. In either arrangement, the wheel end electric motor includes both lubricant support as well as bearing support for optimizing performance of the electric motor in shock load environments.

### CROSS-REFERENCE TO RELATED APPLICATIONS

The subject application is a continuation of U.S. application Ser. No. 16/529,253 filed Aug. 1, 2019, which claims priority to U.S. Provisional Application Ser. No. 62/744,780 filed on Oct. 12, 2018 and U.S. Provisional Application Ser. No. 62/713,595 filed on Aug. 2, 2018, the entire disclosures of which are incorporated herein by reference.

### FIELD OF THE DISCLOSURE

The present disclosure relates generally to a wheel-end electric motor. More specifically, the present disclosure relates to a wheel-end lubricant supported electric motor with additional bearing support.

### BACKGROUND OF THE INVENTION

This section provides a general summary of background information and the comments and examples provided in this section are not necessarily prior art to the present disclosure.

Various drivelines in automotive, truck, and certain off-highway applications take power from a central prime mover and distribute the power to the wheels using mechanical devices such as transmissions, transaxles, propeller shafts, and live axles. These configurations work well when the prime mover can be bulky or heavy, such as, for example, various internal combustion engines (“ICE”). However, more attention is being directed towards alternative arrangements of prime movers that provide improved environmental performance, eliminate mechanical driveline components, and result in a lighter-weight vehicle with more space for passengers and payload.

“On wheel”, “in-wheel” or “near-wheel” motor configurations (i.e, wheel-end motors) are one alternative arrangement for the traditional ICE prime mover that distribute the prime mover function to each or some of the plurality of wheels via one or more motors disposed on, within, or proximate to the plurality of wheels. For example, in one instance, a traction motor, using a central shaft though a rotor and rolling element bearings to support the rotor within a stator, can be utilized as the “on wheel”, “in wheel” or “near wheel” motor configuration. In another instance, a lubricant supported electric motor, such as described in U.S. application Ser. No. 16/144,002, can be utilized as the “on wheel”, “in wheel” or “near wheel” motor configuration. While each of these motor configurations result in a smaller size and lighter weight arrangement as compared to the prime movers based on the internal combustion engine, they each have certain drawbacks and disadvantages. For example, each of these wheel-end electric motor arrangements, when utilized in automotive applications, suffer from failures when the wheel drives over a discontinuous surface (e.g., a pothole or a curb). The shock to the wheel end from the rapid acceleration of the wheel leads to very large forces on the wheel-end motor that often cause the motor's rotor to come into contact with the motor's stator, causing the wheel-end electric motor to fail.

In an effort to address this drawback and disadvantage, various heavy and large support structures have been added to the wheel-end electric motors to withstand the shock load environment. In other words, electric motors for wheel end applications are often engineered with extra mechanical structures, such as extra heavy shafts, and extra heavy bearings, to reduce the probability of failure when the associated wheel encounters a discontinuous road surface. However, adding this extra mechanical support structure to the wheel end motor increases mass and package size, both of which are not optimal for wheel-end applications. Thus, the utilization of wheel-end motors with additional mechanical support structures results in motors that are too heavy and large to be useful and practical for wheel-end applications. Accordingly, there remains a need for improvements to “on wheel”, “in wheel” or “near wheel” motors which improve performance in a wheel-end prime-mover application, particularly when the wheel-end electric motor encounters shock load environments created by travel over discontinuous road surfaces.

### SUMMARY OF THE INVENTION

The subject invention is generally directed to a wheel end lubricant supported electric motor that includes both lubricant support as well as bearing support for optimizing performance of the wheel-end electric motor in shock load environments. It has been found that the utilization of lubricant as support for the rotor and stator, in addition to the support provided by the bearing elements, advantageously addresses and overcomes many of the failures arising when the wheel-end electric motor is utilized in a wheel-end application and encounters wheel-end shock loading from travel over discontinuous road surfaces. Specifically, the auxiliary support provided by the lubricant contributes to radial, structural stiffness of the rotor and stator to help support the rotor in case of high shock loading. The wheel-end motor with lubricant support is also light and small, and thus contributes to the overall design strategy for eliminating weight and size from automobiles and land vehicles. Other advantages will be appreciated in view of the following more detailed description of the subject invention.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic view of a wheel-end lubricant supported electric motor according to a first aspect of the subject disclosure;

FIG. 2 is a schematic view of a wheel-end lubricant supported electric motor according to a second aspect of the subject disclosure; and

FIG. 3 is a schematic view of a wheel-end lubricant supported electric motor according to a third aspect of the subject disclosure.

### DETAILED DESCRIPTION OF THE ENABLING EMBODIMENTS

Example embodiments of a wheel-end lubricant supported electric motor in accordance with the present disclosure will now be more fully described. Each of these example embodiments are provided so that this disclosure is thorough and fully conveys the scope of the inventive concepts, features and advantages to those skilled in the art. To this end, numerous specific details are set forth such as examples of specific components, devices and mechanisms associated with the wheel-end lubricant supported electric motor to provide a thorough understanding of each of the embodiments associated with the present disclosure. However, as will be apparent to those skilled in the art, not all specific details described herein need to be employed, the example embodiments may be embodied in many different forms, and thus should not be construed or interpreted to limit the scope of the disclosure.

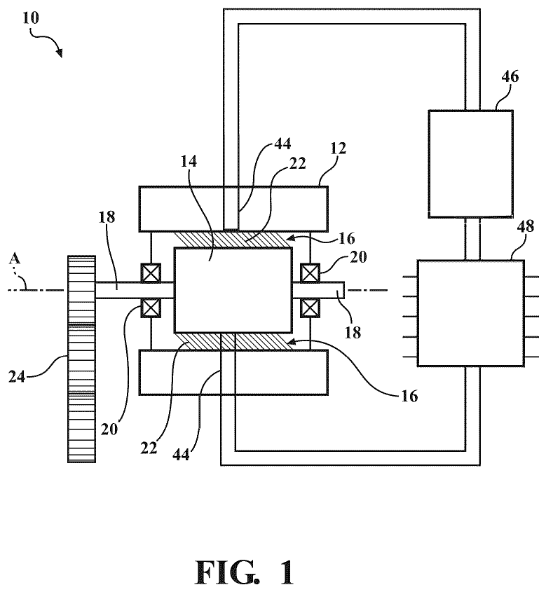

FIGS. 1-3 generally illustrate a wheel-end lubricant supported electric motor 10 in accordance with various aspects of the present disclosure. The lubricant supported electric motor 10 is preferably employed on a vehicle driveline including one or more drive wheels. For example, the lubricant supported electric motor 10 may be incorporated into the front pair of wheels of a vehicle (for front wheel drive). Alternatively, the lubricant supported electric motor 10 may be incorporated into the rear pair of wheels of the vehicle (for rear wheel drive). The lubricant supported electric motor 10 may also be incorporated into all four wheels (of a four wheel vehicle) for four wheel drive. It should be understood that one of the lubricant supported electric motors 10 may be selectively operated such that, using the previous example, the front pair of motors may not be continuously activated, or only activated in a braking function (i.e., regenerative braking). Additionally and alternatively, for a vehicle with more (or less) than four wheels (e.g., a semi-trailer truck, a bus, a tram, a motorcycle, bicycle, scooter, aircraft), the lubricant supported electric motor 10 may be included on one or more (including all) of the wheels. Additionally, it is contemplated that the lubricant supported electric motor 10 may be incorporated into devices other than strictly transportation vehicles, such as toys, medical devices, construction equipment, robotic actuator joints, manufacturing equipment and may be connected to propulsion devices other than wheels and/or tires (tracks, propellers, turbines).

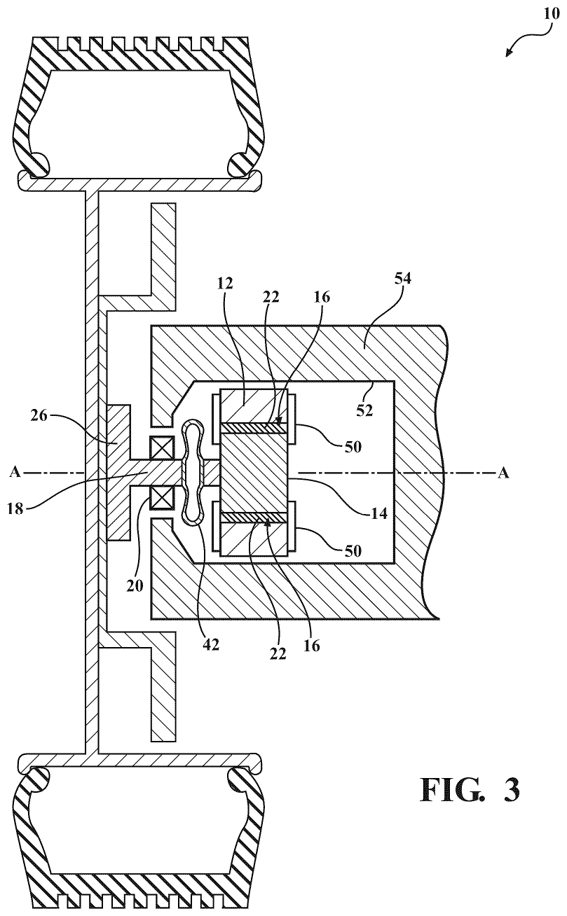

As best illustrated in FIGS. 1-3, the lubricant supported electric motor 10 includes a stator 12 and a rotor 14 extending along an axis A and movably disposed within the stator 12 to define a gap 16 therebetween. A central shaft 18 extends along the axis A and outwardly from the rotor 14 for supporting the rotor 14 within the stator 12. As illustrated in FIGS. 1 and 3, according to a first embodiment of the present disclosure, at least one bearing 20 is disposed in engaging and supporting relationship with the central shaft 18 to provide bearing support to the rotor 14 of the lubricant supported electric motor 10. As further illustrated in FIG. 1, the at least one bearing element 20 can include a plurality of bearing elements 20 to provide this bearing support. For example, the central shaft 18 can extend outwardly from opposing axial sides of the rotor 14 and the plurality of bearing elements 20 can include a pair of bearing elements 20 each disposed on axially opposite sides of the stator 12 and rotor 14 and in supporting relationship with the central shaft 18. In one arrangement, the bearing elements 20 can be comprised of plain bearings. In another arrangement, the bearing elements 20 can be comprised of rolling bearings. However, other forms of bearing elements can be utilized without departing from the scope of the subject disclosure.

As further illustrated in FIGS. 1-3, a lubricant 22 is disposed in the gap 16 for providing additional or auxiliary lubricant support of the rotor 14 within the stator 12. In other words, the lubricant 22 may act as a buffer (e.g., suspension) between the rotor 14 and stator 12 minimizing or preventing contact therebetween and providing lubricant support that complements the bearing support provided by the at least one bearing element 20. The coupling of conventional, bearing elements with the additional, auxiliary support of the lubricant 22 advantageously results in a wheel-end lubricant supported electric motor 10 which is more robust to shock and vibration loading when the wheel-end lubricant supported electric motor 10 is subjected to shock load environments associated with encountering rough, discontinuous road surfaces.

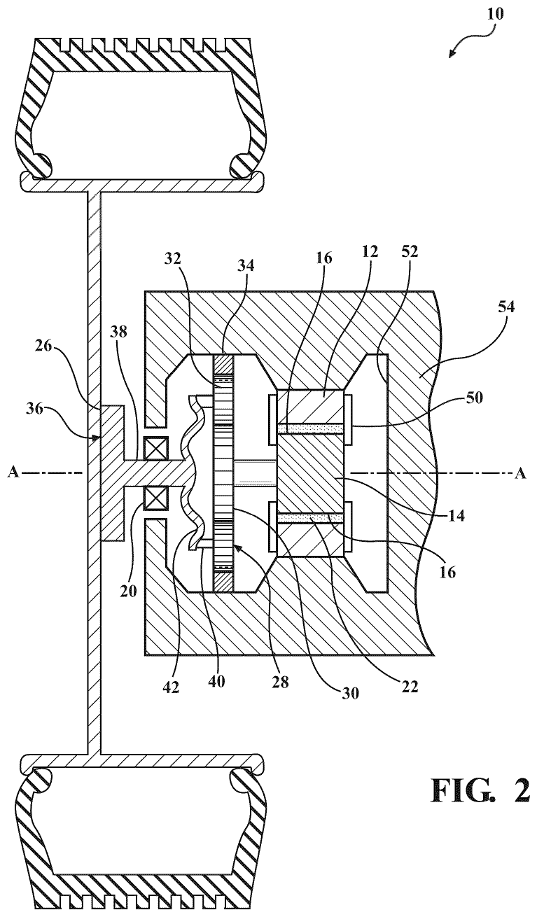

As further illustrated in FIGS. 1-3, the central shaft 18 of the rotor 14 is operably connected to a wheel of a vehicle. For example, as illustrated in FIGS. 1 and 2, the central shaft 18 of the rotor 14 can be operably interconnected to a drive assembly 24 for coupling the wheel-end lubricant supported electric motor 10 to one of the plurality of wheels of a vehicle. However, as illustrated in FIG. 3, in another embodiment, the central shaft 18 of the rotor 14 can extend to and include an integral wheel hub mount 26 extending transverse to the axis A and configured for direct connection to a wheel of a vehicle, or a disk brake rotor associated with the wheel. In either arrangement, the stator 12 and rotor 14 are configured to exert an electromagnetic force therebetween to convert electrical energy into mechanical energy, moving the rotor 14 and ultimately driving the wheel operably coupled to the wheel-end lubricant supported electric motor 10. When a drive assembly 24 is utilized, the drive assemblies 24 may provide one or more reduction ratios between the wheel-end lubricant supported electric motor 10 and the wheel in response to movement of the rotor 14.

As best illustrated in FIG. 2, in one arrangement, the drive assembly 24 may include a planetary gear reducer 28, generally shown, in which the central shaft 18 is interconnected to a sun gear 30, which is configured to engage one or more planetary gears 32. Additionally, and alternatively, the planetary gear reducer 28 can include a ring gear 34 which is configured to engage the one or more planetary gears 32 of the planetary gear reducer 28. The planetary gear reducer 28 may be configured to provide improved power density when compared to a traditional parallel axis drivetrains. The multiple gear contacting surfaces of the planetary gear reducer 28 distribute the axial load evenly on the axis A of the lubricant supported electric motor 10. Additionally, the planetary gear reducer 28 includes only a few contacting surfaces of the sun gear 30, planetary gears 32, and the ring gears 34. Further, the planetary gear reducer 28 can evenly distribute the load from impacts, such as from a vehicle suspension (e.g., a pothole), to the lubricant supported electric motor 10. This wheel mounted lubricant supported electric motor 10 also includes compliance (i.e., flex) in the components of the planetary gear reducr 28 (i.e., ring, sun and planet gears) to avoid an over-constrained wheel mounted drivetrain and excessively close tolerance. However, as noted above, the drive assembly 24 may alternatively include one or more parallel axis gears without departing from the scope of the subject disclosure.

As further illustrated in the aspect of FIG. 2, when the lubricant supported electric motor 10 is operably connected with the planetary gear reducer 28, a wheel hub assembly 36 is also operably connected with the planetary gear reducer 28 to establish the operable connection of the lubricant supported electric motor 10 to a wheel of a vehicle. The wheel hub assembly 36 includes a central hub axle 38 extending in axially aligned relationship with the axis A from a wheel hub mount 26′ configured to receive a wheel attachment (e.g., tire/wheel assembly, track assembly) and/or a brake attachment (e.g., brake assembly, disk brake rotor) to a gear mount 40 disposed in operably interconnected relationship with the planetary gears 32. In this arrangement, the at least one bearing 20′ is disposed in supporting and engaging relationship with the central hub axle 38 instead of the central shaft 18 of the lubricant supported electric motor 10. The weight and package space requirements of the lubricant supported electric motor 10 can advantageously be reduced in this arrangement by having the lubricant supported electric motor 10 directly support the sun gear 30 (i.e., input gear) of the planetary gear reducer 28. In other words, the load carrying capacity of the lubricant supported electric motor 10 can advantageously be used to carry the sun gear 30 of the planetary gear reducer 28. This type of configuration may also be used to support the input of other forms of mechanical speed reduction such as traction drives, variable ratio traction drives and chain drives.

As further illustrated in FIG. 2, the gear mount 40 of the wheel hub assembly includes a wavy spring 42 disposed between the at least one bearing 20′ and the planetary gears 32. In this arrangement, the central hub axle 38 is stiff in bending and torsional loads to the left of the at least one bearing 20′ and compliant in bending but stiff in torsion to the right of the at least one bearing 20′. In an alternative arrangement, and as best illustrated in FIG. 3, when the lubricant supported electric motor 10 is connected directly to the wheel, the central shaft 18 includes the wavy spring 42 disposed between the at least one bearing 20 and the rotor 14. Similar to the arrangement in FIG. 2, the central shaft 18 is stiff in bending and torsional loads to the left of the at least one bearing 20 and compliant in bending but stiff in torsion to the right of the at least one bearing 20.

As best illustrated FIG. 1, the stator 12 defines a passageway 44 disposed in fluid communication with the gap 16 for introducing the lubricant 22. However, the passageway 44 could be provided on any other components of the lubricant supported electric motor 10 without departing from the subject disclosure. The lubricant supplied journal bearing fitted between the rotor 14 and stator 12 provides the wheel-end lubricant supported electric motor 10 with hydrostatic and/or hydrodynamic support structures. In other words, the lubricant supply to the gap 16 determines the hydrodynamic and hydrostatic properties of the wheel-end lubricant supported electric motor 10, and the characteristics of the lubricant supply determine how the lubricant supported electric motor 10 with both bearing and lubricant support behaves in operation. For example, according to an aspect, the lubricant 22 may have a very, low viscosity. According to another aspect, the lubricant 22 may be a liquid with a significant amount of entrained gas. This reduces shear loss in normal operation and provides for some hydrodynamic bearing support (i.e., auxiliary/additional lubricant support) and some boundary mode lubrication. In all cases, the lubricant 22 can also help to conduct heat away from heat-generating parts of the wheel-end motor 10, such as the stator windings.

According to an aspect, the lubricant 20 may be cycled or pumped through the passageway 44 and into the gap 16 in various ways. For example, as best illustrated in FIG. 1, a high pressure source 46 (e.g., a pump) of the lubricant 22 may be fluidly coupled to a low pressure source (e.g., a sump, not shown) of the lubricant 22, where the lubricant may move from the high pressure source to the lower pressure source, through the passageway 44 and into the gap 16. Rotation of the rotor 14 relative to the stator 12 may operate as a self-pump to drive lubricant 20 through the passageway 30 and into the gap 16. As further illustrated in FIG. 1, the high pressure source (e.g. pump) 46 may be fluidly coupled to a heat exchanger 48 for removing heat from the lubricant 22. As further shown in FIG. 1, the rotor 14 presents an inner raceway and the stator 12 presents an outer raceway. According to an aspect, each of the inner and outer raceways are configured for boundary lubrication and minimal lubricant supply. Although not expressly illustrated in FIGS. 2 and 3, it should be understood that each of the passageway 44, the high pressure source 46, and the heat exchanger 48 are also included and incorporated into each of these additional aspects of the lubricant supported electric motor 10.

As best illustrated in FIGS. 2 and 3, the lubricant supported electric motor 10 may also include a plurality of thrust bearing plates 50 disposed in overlaying relationship with opposing sides of the rotor and the stator, and extending transverse to the axis on opposing sides of the lubricant supported electric motor 10 to cover the gap 16 and seal/retain the lubricant 22 therein. The thrust bearing plates 50 also support the axial load of the lubricant supported electric motor 10 and thus assist in keeping the rotor 14 centered within the stator 12. The thrust bearing plates 50 may also be configured to prevent contaminants, such as other non-compatible lubricants, dirt, or other debris, from entering the gap 16 of the lubricant supported electric motor 10. In this example, the thrust bearing plates 50 maintain the separation of the lubricant 22 in the gap 16 from other materials disposed in and around an environment of the lubricant supported motor.

As best illustrated in FIGS. 2 and 3, the lubricant supported electric motor 10, when mounted in its “on-wheel”, “in-wheel”, or “near-wheel” configuration, can be disposed inside of an interior cavity 52 of a housing 54. For example, as best illustrated in FIG. 3, the housing 54 can be comprised of a wheel knuckle support that houses the lubricant supported electric motor 10. In this instance, the housing 54, e.g, wheel support knuckle, may include or incorporate the at least one bearing 20 which supports the central shaft 18 extending outwardly from the rotor 14 of the lubricant supported electric motor 10. In this arrangement, a disc brake rotor is also shown connected to the wheel and/or tire, and as well as the wheel hub of the central shaft 15. Additionally and alternatively, another lubricant may be disposed within the cavity 52 defined by the wheel support knuckle and retained within by the at least one bearing 18.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A wheel-end electric motor comprising:
a stator;
a rotor extending along an axis and movably disposed within said stator to define a gap therebetween;
a central shaft extending along said axis and outwardly from said rotor into operably connected relationship with a wheel of a vehicle;
at least one bearing element disposed in supporting relationship with said central shaft to provide bearing support of said rotor within said stator;
a pump disposed in fluid communication with said gap for introducing a pressurized lubricant into said gap; and
said pressurized lubricant disposed in said gap continuously between said rotor and said stator to establish auxiliary lubricant support of said rotor within said stator to complement the bearing support provided by the at least one bearing element.

2. The wheel-end electric motor as set forth in claim 1, wherein said at least one bearing element includes a plurality of bearing elements.

3. The wheel-end electric motor as set forth in claim 2, wherein said central shaft extends outwardly from opposing axial sides of said rotor and said plurality of bearing elements include a pair of bearing elements each disposed adjacent one of said axially opposite sides of said rotor in supporting relationship with a respective portion of said central shaft.

4. The wheel-end electric motor as set forth in claim 1, wherein said central shaft of said rotor extends to a wheel hub mount being integral with said central shaft and configured to receive the wheel of the vehicle to establish the operably coupled relationship.

5. The wheel-end electric motor as set forth in claim 5, wherein said central shaft includes a wavy spring disposed between said at least one bearing and said rotor.

6. The wheel-end electric motor as set forth in claim 1, wherein said central shaft of said rotor is operably interconnected to a drive assembly for coupling the wheel-end electric motor to the wheel of a vehicle and establishing the operably coupled relationship.

7. The wheel end electric motor as set forth in claim 6, wherein said drive assembly is comprised of a planetary gear reducer.

8. The wheel end electric motor as set forth in claim 1, wherein said at least one bearing is comprised of a plain bearing.

9. The wheel end electric motor as set forth in claim 1, wherein said at least one bearing is comprised of a rolling bearing.

10. The wheel end electric motor as set forth in claim 1, wherein said stator defines a passageway disposed in fluid communication with said gap and said pump for establishing the fluid communication between said pump and said gap.

11. The wheel end electric motor as set forth in claim 10, wherein said pump is fluidly coupled to a heat exchanger for removing heat from said lubricant.
